(19) United States
(12) Patent Application Publication
(10) Pub. No.: US 2020/0380870 A1
(43) Pub. Date: Dec. 3, 2020

(54) VEHICLE CONTROL DEVICE AND VEHICLE CONTROL SYSTEM

(71) Applicant: TOYOTA JIDOSHA KABUSHIKI KAISHA, Toyota-shi (JP)

(72) Inventors: Maiko EGUCHI, Tokyo (JP); Masao HITOMI, Toyota-shi (JP); Yu NISHIKATA, Tokyo (JP); Kousuke MATSUYAMA, Tokyo (JP); Seiji KUROKI, Tokyo (JP); Hiroaki KAWAHARA, Tokyo (JP)

(73) Assignee: TOYOTA JIDOSHA KABUSHIKI KAISHA, Toyota-shi (JP)

(21) Appl. No.: 16/880,305

(22) Filed: May 21, 2020

(30) Foreign Application Priority Data
May 30, 2019 (JP) 2019-101013

(51) Int. Cl. G08G 1/00; B60W 30/18; B60W 30/165; G05D 1/10; G05D 1/00

(52) U.S. Cl. CPC G08G 1/22; B60W 30/18163; G05D 1/0094; G05D 1/101; B60W 30/165

(57) ABSTRACT

There is provided an ECU which is a vehicle control device that controls platooning in which a plurality of vehicles M1 to M4 travel while forming a platoon Co, the device including: an acquisition unit configured to acquire a situation of a vehicle around the plurality of vehicles M1 to M4 based on an imaging result by a camera of a drone that flies around the plurality of vehicles M1 to M4; a determination unit configured to determine whether or not the surrounding vehicles are capable of entering between two vehicles M included in the plurality of vehicles M1 to M4 in accordance with the situation of the surrounding vehicles acquired by the acquisition unit; and a vehicle control unit configured to shorten a distance between the plurality of vehicles M1 to M4 when the determination unit determines that the surrounding vehicles are capable of entering.

### TECHNICAL FIELD

The present invention relates to a vehicle control device and a vehicle control system for controlling platooning in which a plurality of vehicles travel while forming a platoon.

### CROSS-REFERENCE TO RELATED APPLICATION

This application claims the benefit of priority from Japanese Patent Application No. 2019-101013 filed May 30, 2019, the entire contents of which are incorporated herein by reference.

### BACKGROUND

Patent Literature 1 (Japanese Unexamined Patent Publication No. 2019-28733) describes a platooning system that controls a plurality of vehicles that platoon by automatic driving. According to the technique of Patent Literature 1, it is possible to smoothly change lanes of a plurality of vehicles.

Here, when performing platooning, it is likely to become difficult to grasp the surrounding road conditions, especially for vehicles other than the vehicles at the head and end in the platoon. For example, when another vehicle joins the lane on which the platoon of vehicles travel at the junction of a highway, another vehicle enters between the plurality of vehicles that form the platoon, and there is a concern that the platoon is disturbed and the platooning becomes impossible.

The present invention has been made in view of the above-described circumstances, and an object thereof is to provide a vehicle control device and a vehicle control system capable of avoiding disturbance of a platoon during the platooning.

### SUMMARY

According to an aspect of the present invention, there is provided a vehicle control device that controls platooning in which a plurality of vehicles travel while forming a platoon, the device including: an acquisition unit configured to acquire a situation of a vehicle around the plurality of vehicles based on an imaging result by an imaging unit of a drone that flies around the plurality of vehicles; a determination unit configured to determine whether or not the surrounding vehicles are capable of entering between two vehicles included in the plurality of vehicles in accordance with the situation of the surrounding vehicles acquired by the acquisition unit; and a vehicle control unit configured to shorten a distance between the plurality of vehicles when the determination unit determines that the surrounding vehicles are capable of entering.

In the vehicle control device according to the aspect of the present invention, the situation of a vehicle around the plurality of vehicles that form the platoon, which is imaged by the imaging unit of the drone, is acquired, it is determined whether or not the surrounding vehicles can enter between the vehicles that form the platoon in accordance with the situation of the surrounding vehicles, and the plurality of vehicles are controlled such that the distance (that is, inter-vehicle distance) between the plurality of vehicles is shortened when it is determined that the surrounding vehicles can enter. As described above, by acquiring the situation of the surrounding vehicles, which is imaged by the imaging unit of the drone, it is possible to appropriately grasp the situation of the vehicles around the platoon even when the platoon is formed. In addition, in accordance with the situation of the surrounding vehicles, when the surrounding vehicles can enter between the plurality of vehicles that form the platoon, the plurality of vehicles are controlled such that the distance between the plurality of vehicles that form the platoon is shortened, and accordingly, it is possible to avoid entry of another vehicle between the plurality of vehicles, that is, the disturbance of the platoon during the platooning. As described above, according to the vehicle control device of the aspect of the present invention, it is possible to provide a vehicle control device capable of avoiding the disturbance of the platoon during the platooning.

When the plurality of vehicles are traveling on a highway, the acquisition unit may acquire a situation of the vehicle that travels on a merging lane of the highway as the situation of the surrounding vehicles, and the determination unit may determine whether or not the vehicle that travels on the merging lane is capable of entering between two vehicles included in the plurality of vehicles at a junction of vehicles that travel on the merging lane. At the junction (exit) of a highway, other vehicles enter especially between the plurality of vehicles that form the platoon, and the platoon is likely to be disturbed. In this regard, the situation of the vehicle that travels on the merging lane of the highway is acquired, it is determined whether or not the vehicle that travels on the merging lane can enter between the plurality of vehicles at the junction, and accordingly, even at the junction of the highway where the platoon is likely to be disturbed, it is possible to appropriately avoid the disturbance of the platoon.

The vehicle control unit may decelerate or accelerate the plurality of vehicles in accordance with an expected position of a vehicle that travels on the merging lane with respect to the plurality of vehicles at the junction. In addition to shortening the distance between the plurality of vehicles that form the platoon, for example, when the vehicle at the head of the platoon and the expected position of the vehicle that travels on the merging lane are close to each other (the entry of another vehicle is likely to occur at the head) at the junction, the plurality of vehicles that form the platoon is decelerated, and the vehicle that travels on the merging lane is allowed to go first. At the same time, for example, when the vehicle at the end of the platoon and the expected position of the vehicle that travels on the merging lane are close to each other (the entry of another vehicle is likely to occur at the end) at the junction, the plurality of vehicles that form the platoon are accelerated and travel ahead of the vehicle that travels on the merging lane, and accordingly, it is possible to more reliably avoid the entry of the vehicle that travels on the merging lane between the plurality of vehicles that form the platoon, and to more reliably avoid the disturbance of the platoon.

The vehicle control unit may determine whether to decelerate or accelerate the plurality of vehicles in consideration of a load amount of the plurality of vehicles. Since the speed of the plurality of vehicles changes in accordance with the load amount, it is determined whether to decelerate or accelerate in consideration of the load amount, and accordingly, it is possible to more reliably avoid the entry of the vehicle that travels on the merging lane between the plurality of vehicles that form the platoon.

The acquisition unit may acquire a separation distance in a traveling direction between the plurality of vehicles and a vehicle that travels on a lane next to a lane on which the plurality of vehicles travel, as the situation of the surrounding vehicles, and the determination unit may determine that the surrounding vehicles are capable of entering between two vehicles included in the plurality of vehicles when the separation distance becomes smaller than a predetermined value. As described above, when the relative distance in the traveling direction with respect to the vehicle that travels on the next lane is shortened, that is, when the vehicle that travels on the next lane is likely to enter between the plurality of vehicles that form the platoon when the vehicle has changed the lane, it is determined that the vehicle can enter, and accordingly, when the possibility of entry is high, it is possible to appropriately shorten the distance between the plurality of vehicles that form the platoon, and to more reliably avoid the disturbance of the platoon.

According to the present invention, it is possible to provide a vehicle control device and a vehicle control system capable of avoiding the disturbance of the platoon during the platooning.

### BRIEF DESCRIPTION OF THE DRAWINGS

FIG. 1 is a diagram schematically showing an example of a use scene of a vehicle control system according to an embodiment.

FIG. 2 is a view showing a schematic configuration of the vehicle control system according to the embodiment.

FIG. 3 is a flowchart showing a process executed by an ECU.

### DETAILED DESCRIPTION

Hereinafter, embodiments of the present invention will be described in detail with reference to the accompanying drawings. In the description of the drawings, the same or equivalent elements will be given the same reference numerals, and the redundant description thereof will be omitted.

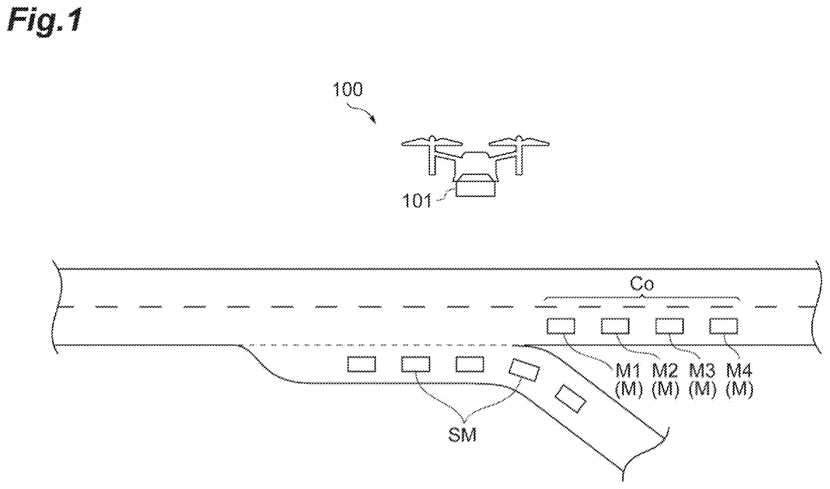

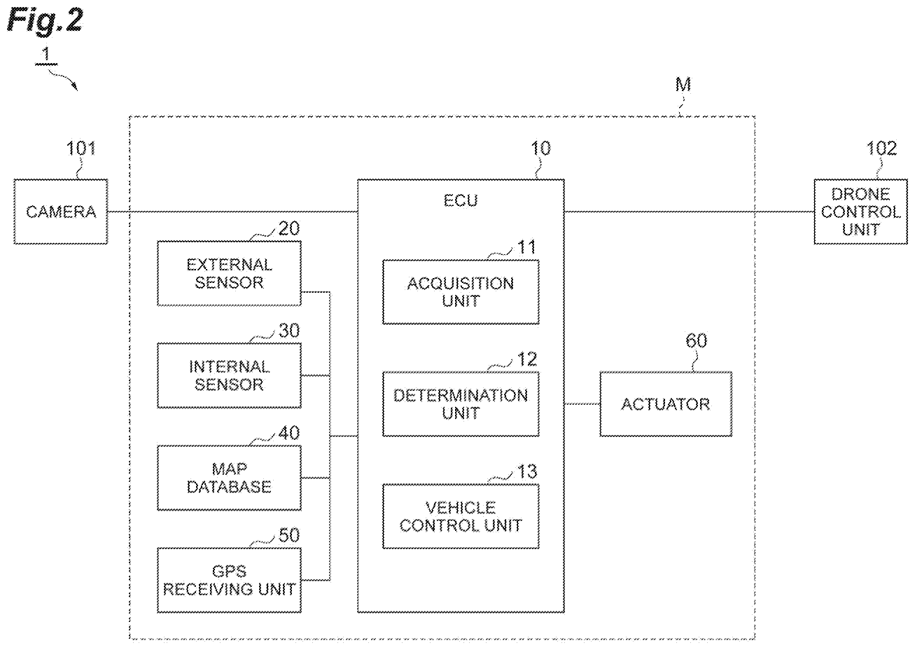

FIG. 1 is a view schematically showing an example of a use scene of a vehicle control system according to the present embodiment. The vehicle control system according to the present embodiment is a system that controls platooning in which a plurality of vehicles M1 to M4(M) travel while forming a platoon Co. In the vehicle control system, the ECUs 10 (vehicle control devices) of each of the vehicles M1 to M4 (refer to FIG. 2) communicate with each other in the plurality of vehicles M1 to M4, and accordingly, platooning is realized in which the vehicle speed and the positional relationship of each of the vehicles M1 to M4 are grasped and the following vehicle follows the vehicle M that travels immediately before the following vehicle considering the vehicle M as the preceding vehicle (automatic driving is performed). In platooning, for example, a driver may be present only in the vehicle M1 at the head, and no driver may be present in the other vehicles M2 to M4. In the vehicle control system, the vehicle speed is normally controlled within a range of the maximum speed or less, and the inter-vehicle distance is controlled to an appropriate distance that corresponds to the vehicle speed at each time. Then, in the vehicle control system, a drone 100 images the part around the plurality of vehicles M1 to M4 that form the platoon Co. The drone 100 flies around the plurality of vehicles M1 to M4 that follow the platoon Co, and has a camera 101. The drone 100 moves to an imaging location that corresponds to an instruction from the ECU 10 (refer to FIG. 2) (details will be described later). Then, the camera 101 performs imaging at the imaging location (around the plurality of vehicles M1 to M4).

In the example shown in FIG. 1, the drone 100 moves to a junction (exit) of a highway positioned in front of the platoon Co in accordance with the instruction from the ECU 10 (refer to FIG. 2). The junction of the highway is a location where other vehicles (surrounding vehicles SM that travel on the merging lane) are likely to enter between the plurality of vehicles M1 to M4 that form the platoon Co, that is, the platoon Co is disturbed and the platooning is likely to become impossible. In the vehicle control system according to the present embodiment, the ECU 10 (refer to FIG. 2) acquires the situation of the surrounding vehicle SM from the camera 101 of the drone 100, the control to shorten the distance (inter-vehicle distance) between the plurality of vehicles M1 to M4 is performed in accordance with the situation of the surrounding vehicle, and accordingly, the disturbance of the platoon Co is avoided, for example, even at the location where the platoon Co is likely to be disturbed, such as the junction of the highway, and continuation of the platooning is realized.

FIG. 2 is a view showing a schematic configuration of the vehicle control system 1 according to the present embodiment. As shown in FIG. 2, the vehicle control system 1 includes an ECU 10 (vehicle control device), an external sensor 20, an internal sensor 30, a map database 40, a GPS receiving unit 50, an actuator 60, a camera 101 (an imaging unit of the drone 100) and a drone control unit 102. Each component of the vehicle control system 1 except for the camera 101 and the drone control unit 102 is mounted on a vehicle M such as a truck.

The ECU 10 is a vehicle control device that controls platooning in which the plurality of vehicles M1 to M4 travel while forming the platoon Co. The ECU 10 is an electronic control unit having a central processing unit (CPU), a read only memory (ROM), a random access memory (RAM), a controller area network (CAN) communication circuit, and the like. In the ECU 10, various functions are realized by loading a program stored in the ROM into the RAM and executing the program loaded in the RAM by the CPU. The ECU 10 may include a plurality of electronic control units. The external sensor 20, the internal sensor 30, the map database 40, the GPS receiving unit 50, the actuator 60, the camera 101, and the drone control unit 102 are connected to the ECU 10 via a CAN communication circuit.

The external sensor 20 includes a radar unit, a camera, and the like, and detects information that indicates a situation around the host vehicle M. For example, the radar unit is set to have a detection range around the host vehicle M such that a leading vehicle in the lane on which the host vehicle M is traveling or a surrounding vehicle that travels on a next lane is detected. The radar unit includes, for example, a millimeter wave radar that emits a millimeter wave as a detection wave around the host vehicle M and a laser radar that emits infrared light as a detection wave around the host vehicle M. The radar unit acquires obstacle information that indicates a distance and a relative speed of an obstacle positioned nearby with respect to the host vehicle M based on a reflected wave of the emitted detection wave. In the camera, an area around the host vehicle M is set as an imaging range such that a leading vehicle or a surrounding vehicle is imaged. The camera acquires image information of an area around the host vehicle M. The external sensor 20 outputs the obstacle information and the image information to the ECU 10 as information indicating a situation around the host vehicle M.

The internal sensor 30 detects various types of information related to the traveling situation of the host vehicle M. The internal sensor 30 includes, for example, a vehicle speed sensor for detecting a vehicle speed, an acceleration/deceleration sensor for detecting acceleration and deceleration, a steering angle sensor for detecting a steering angle of steering, and the like. The internal sensor 30 outputs a detection value of each sensor to the ECU 10 as detection value information.

The map database 40 is a database having map information configured with nodes that indicate intersections, junctions, and the like and links that are road sections connecting the nodes to each other, and is stored in a storage device mounted on the host vehicle M. The map information includes, for example, node information including the position and type of each node, and link information including the number of lanes, curvature, and gradient in addition to the type and link length of each link. In addition, the map information includes information on the junction (a merging lane or the like) of the highway. The map database 40 may be stored in a computer such as a facility that can communicate with the ECU 10.

The GPS receiving unit 50 receives GPS signals from three or more GPS satellites (not shown), and acquires GPS information indicating the current position (for example, latitude and longitude) of the host vehicle M based on the received GPS signals. The GPS receiving unit 50 outputs GPS information to the ECU 10.

The actuator 60 is a device that executes control of the traveling of the vehicle M. The actuator 60 includes at least an engine actuator, a brake actuator, and a steering actuator. The engine actuator controls the amount of air supplied to the engine (throttle opening) in accordance with a control signal from the ECU 10 to control the driving force of the vehicle M. When the vehicle M is a hybrid vehicle, the control signal from the ECU 10 is input to a motor as a power source in addition to the amount of air supplied to the engine to control the driving force. When the vehicle M is an electric car, the control signal from the ECU 10 is input to a motor as a power source to control the driving force. The brake actuator controls the brake system in accordance with the control signal from the ECU 10 and controls the braking force applied to the wheels of the vehicle M. As the brake system, a hydraulic brake system can be used. The steering actuator controls driving of an assist motor that controls a steering torque in the electric power steering system in accordance with the control signal from the ECU 10. Accordingly, the steering actuator controls the steering torque of the vehicle M.

The camera 101 is provided on the drone 100 that flies around the plurality of vehicles M1 to M4 that form the platoon Co, and is an imaging unit that images the surrounding of the plurality of vehicles M1 to M4. The camera 101 outputs information of the captured image (imaging result) to the ECU 10. The drone control unit 102 moves the drone 100 to the imaging location in accordance with an instruction signal from the ECU 10.

Next, a functional configuration of the ECU 10 will be described with reference to FIG. 2. The ECU 10 includes an acquisition unit 11, a determination unit 12, and a vehicle control unit 13.

The acquisition unit 11 acquires the situation of the vehicles around the plurality of vehicles M1 to M4 based on the imaging result of the camera 101 of the drone 100 that flies around the plurality of vehicles M1 to M4. The acquisition unit 11 specifies vehicles around the plurality of vehicles M1 to M4 from the imaging result by, for example, image recognition technology.

The acquisition unit 11 determines an imaging location to be acquired in accordance with the current location of the vehicle M. The acquisition unit 11 specifies the current value of the vehicle M based on the GPS information input from the GPS receiving unit 50. The acquisition unit 11 specifies the characteristics of the current location of the vehicle M by referring to the map information in the map database 40. For example, when the current location of the vehicle M is on a highway and is around a junction (exit) of the highway, more specifically, at a position several seconds to several tens of seconds before reaching the junction, the acquisition unit 11 determines the location where the merging lane of the highway can be imaged as the imaging location. In other cases, the acquisition unit 11 determines, as an imaging location, a location on the lane next to the lane on which the vehicle M travels where the part in front of and behind the vehicle M in the traveling direction can be imaged. The acquisition unit 11 transmits an instruction signal to the drone control unit 102 such that the drone 100 moves to the determined imaging location.

As described above, the acquisition unit 11 determines the location that can image the merging lane of the highway as an imaging location when the plurality of vehicles M1 to M4 are traveling on the highway (more specifically, when the vehicles are traveling on the highway and approaching the junction of the highway), and acquires the situation of the vehicle that travels on the merging lane of the highway as a situation of the surrounding vehicle from the imaging result of the camera 101 at the imaging location. In addition, in other cases, the acquisition unit 11 determines, as an imaging location, a location on the lane next to the lane on which the vehicle M travels where the part in front of and behind the vehicle M in the traveling direction can be imaged, and acquires, as a situation of the surrounding vehicle, the separation distance in the traveling direction between the plurality of vehicles M1 to M4 and the vehicle that travels in the lane next to the lane on which the plurality of vehicles M1 to M4 travel, from the imaging result of the camera 101 at the imaging location. In addition, the acquisition unit 11 may acquire the separation distance based on information input to the external sensor 20. The acquisition unit 11 outputs the acquired information to the determination unit 12. Further, the acquisition unit 11 may output the imaging result of the camera 101 to an on-vehicle monitor (not shown) and notify the driver of the situation in the vicinity of the exit to the highway.

The determination unit 12 determines whether or not the surrounding vehicle can enter between the two vehicles included in the plurality of vehicles M1 to M4 in accordance with the situation of the surrounding vehicles acquired by the acquisition unit 11. When the situation of the vehicle that travels on the merging lane of the highway is acquired as the situation of the surrounding vehicles, and the determination unit 12 determines whether or not the vehicle that travels on the merging lane can enter between two vehicles included in the plurality of vehicles M1 to M4 at the junction of vehicles that travel on the merging lane. The determination unit 12 considers the vehicle speed of the host vehicle M input from the internal sensor 30, the position of each vehicle that travels on the merging lane, and the like, and determines whether or not the vehicle that travels on the merging lane can enter between the two vehicles included in the plurality of vehicles M1 to M4 at the junction.

In addition, when the separation distance in the traveling direction between the plurality of vehicles M1 to M4 and the vehicle that travels on the lane next to the lane on which the plurality of vehicles M1 to M4 travel is acquired as the situation of the surrounding vehicles, and when the separation distance became smaller than a predetermined value, the determination unit 12 determines that the surrounding vehicles can enter between two vehicles included in the plurality of vehicles M1 to M4. For example, when the lane on which the host vehicle M travels is an overtaking lane and the next lane is not an overtaking lane (normal lane), and when the separation distance between the vehicle that travels ahead in the traveling direction of the next lane and the host vehicle M became short, if the vehicle that travels ahead changes the lane to the overtaking lane, there is a concern that the vehicle that travels ahead enters between the plurality of vehicles M1 to M4. In addition, for example, when the lane on which the host vehicle M travels is a normal lane and the next lane is an overtaking lane, and when the separation distance between the vehicle that travels behind in the traveling direction of the next lane and the host vehicle M became short, if the vehicle that travels behind changes the lane to the normal lane, there is a concern that the vehicle that travels behind enters between the plurality of vehicles M1 to M4. Therefore, when the separation distance in the traveling direction between the plurality of vehicles M1 to M4 and the vehicle that travels on the lane next to the lane on which the plurality of vehicles M1 to M4 travel became short, it is preferable to determine that the surrounding vehicles can enter between the plurality of vehicles M1 to M4. The determination unit 12 outputs a determination result to the vehicle control unit 13.

The vehicle control unit 13 controls the actuator 60 to shorten the distance (inter-vehicle distance) between the plurality of vehicles M1 to M4 when the determination unit 12 determines that the surrounding vehicle can enter between the plurality of vehicles M1 to M4. The inter-vehicle distance control here is a control that is different (separately performed) from the inter-vehicle distance control that corresponds to the normal vehicle speed. Shortening the inter-vehicle distance means that the inter-vehicle distance is shortened at least more than the inter-vehicle distance at the normal vehicle speed of the vehicle M in a state where the determination unit 12 does not determine that the vehicle M can enter. In addition, since the normal vehicle speed of the vehicle M is different depending on the road (whether the vehicle is a highway or a general road, and the like), “the inter-vehicle distance can be shortened more than the inter-vehicle distance at a normal vehicle speed” is satisfied when comparing the inter-vehicle distances between the same roads.

When the determination unit 12 determines that the vehicle that travels on the merging lane can enter between the plurality of vehicles M1 to M4 at the junction, the vehicle control unit 13 accelerates or decelerates the plurality of vehicles M1 to M4 in accordance with the expected position of the vehicle that travels on the merging lane with respect to the plurality of vehicles M1 to M4 at the junction. In other words, the vehicle control unit 13 controls the actuator 60 such that the plurality of vehicles M1 to M4 decelerate when the vehicle that travels on the merging lane enters (or comes into contact with) before the n-th vehicle from the head of the platoon Co at the junction, and controls the actuator 60 such that the plurality of vehicles M1 to M4 accelerate when the vehicle enters (or comes into contact with) after the n-th vehicle. When the entry of the vehicle that travels on the merging lane is likely to occur at the head of the platoon Co at the junction, the plurality of vehicles M1 to M4 are decelerated such that the vehicles that travel on the merging lane go first, and when the entry of the vehicle that travels on the merging lane is likely to occur at the end of the platoon Co at the junction, the plurality of vehicles M1 to M4 are accelerated to travel ahead of the vehicle that travels on the merging lane. Accordingly, it is possible to more reliably avoid the entry of the vehicle that travels on the merging lane between the plurality of vehicles M1 to M4 that form the platoon Co. In addition, the value of the threshold value n may be, for example, a median value (for example, the third vehicle when there are five vehicles) of the platoon Co, or may be a value (for example, the fifth vehicle when there are five vehicles) at the end of the platoon Co such that deceleration is likely to occur with emphasis on safe driving.

The vehicle control unit 13 may determine whether to decelerate or accelerate the plurality of vehicles in consideration of a load amount of the plurality of vehicles M. In other words, the vehicle control unit 13 may reduce the value of the above-described threshold value n, for example, as the load amount is smaller. This is because the speed of the vehicle M is likely to increase as the load amount is smaller.

In addition, for the vehicle M where the driver is located, the control of the vehicle control unit 13 does not necessarily have to be the control of the actuator 60, and the vehicle control unit 13 may notify an on-vehicle monitor (not shown) of the shortening of the distance between the plurality of vehicles M1 to M4, deceleration of the vehicles M1 to M4, and the like. In other words, for a vehicle where the driver is located, control of the inter-vehicle distance and the like may not be performed automatically.

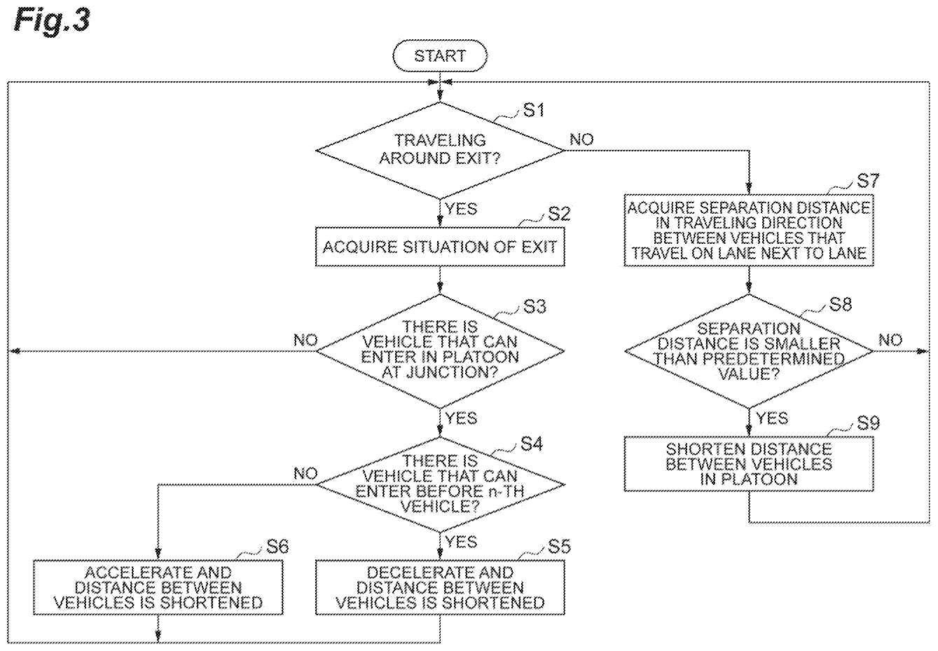

Next, a process (vehicle control) executed by the ECU 10 will be described with reference to FIG. 3. FIG. 3 is a flowchart showing a process executed by the ECU 10.

As shown in FIG. 3, first, the acquisition unit 11 determines whether or not the plurality of vehicles M1 to M4 that form the platoon Co are traveling around the junction (exit) of the highway (step S1). Specifically, the acquisition unit 11 specifies the current value of the vehicle M based on the GPS information input from the GPS receiving unit 50, and refers to the map information in the map database 40 to determine whether or not the current location of the vehicle M is on the highway and around the junction (exit) of the highway, more specifically, at a position several seconds to several tens of seconds before reaching the junction.

When it is determined in step S1 that the plurality of vehicles M1 to M4 that form the platoon Co are traveling around the junction (exit) of the highway, the acquisition unit 11 determines the imaging location to the exit (a location where the merging lane can be imaged) of the highway, and transmits an instruction signal to the drone control unit 102 such that the drone 100 moves to the imaging location. In addition, the acquisition unit 11 acquires the situation of the exit based on the imaging result of the camera 101 at the imaging location (step S2). Specifically, the acquisition unit 11 acquires, as the situation of the surrounding vehicles, the situation of the vehicle that travels on the merging lane of the highway.

Subsequently, the determination unit 12 determines whether or not there is a vehicle that can enter between the plurality of vehicles M1 to M4 included in the platoon Co at the junction of the vehicles that travel on the merging lane (step S3). The determination unit 12 considers the vehicle speed of the host vehicle M input from the internal sensor 30, the position of each vehicle that travels on the merging lane, and the like, and determines whether or not the vehicle that travels on the merging lane can enter between the two vehicles included in the plurality of vehicles M1 to M4 at the junction. When it is determined in step S3 that there is no vehicle that can enter, the process of step S1 is performed again.

When it is determined in step S3 that there is a vehicle that can enter, the vehicle control unit 13 determines whether or not the vehicle can enter before the n-th vehicle from the head of the platoon Co (step S4). When it is possible to enter before the n-th vehicle, the vehicle control unit 13 controls the actuator 60 such that the plurality of vehicles M1 to M4 decelerate and the distance (inter-vehicle distance) between the plurality of vehicles M1 to M4 is shortened (step S5). Meanwhile, when the vehicle can enter after the n-th vehicle, the vehicle control unit 13 controls the actuator 60 such that the plurality of vehicles M1 to M4 accelerate and the distance (inter-vehicle distance) between the plurality of vehicles M1 to M4 is shortened (step S6). After the process of step S5 or step S6 is performed, the process of step S1 is performed again.

When it is determined in step S1 that the plurality of vehicles M1 to M4 that form the platoon Co is not traveling around the junction (exit) of the highway, the acquisition unit 11 determines the imaging location as a location on the lane next to the lane on which the vehicle M travels where the part in front of and behind the vehicle M can be imaged, and transmits the instruction signal to the drone control unit 102 such that the drone 100 moves to the imaging location. Then, the acquisition unit 11 acquires the separation distance in the traveling direction between the plurality of vehicles M1 to M4 and the vehicles that travel on the lane next to the lane on which the plurality of vehicles M1 to M4 travel based on the imaging result of the camera 101 at the imaging location (step S7).

Subsequently, the determination unit 12 determines whether or not the separation distance is smaller than a predetermined value, and when the separation distance is smaller than the predetermined value, the determination unit 12 determines that the surrounding vehicle can enter between the plurality of vehicles M1 to M4 (step S8). When it is determined in step S8 that the separation distance is smaller than the predetermined value, the process of step S1 is performed again.

When it is determined in step S8 that the separation distance is smaller than the predetermined value, the vehicle control unit 13 controls the actuator 60 such that the distance (inter-vehicle distance) between the vehicles M1 to M4 in the platoon Co is shortened (step S9). After the process in step S9 is performed, the process in step S1 is performed again.

Next, the effects of the present embodiment will be described.

The ECU 10 according to the present embodiment is the vehicle control device that controls platooning in which the plurality of vehicles M1 to M4 travel while forming the platoon Co, and includes: the acquisition unit 11 that acquires the situation of the vehicle around the plurality of vehicles M1 to M4 based on the imaging result by the camera 101 of the drone 100 that flies around the plurality of vehicles M1 to M4; the determination unit 12 configured to determine whether or not the surrounding vehicles are capable of entering between two vehicles M included in the plurality of vehicles M1 to M4 in accordance with the situation of the surrounding vehicles acquired by the acquisition unit 11; and the vehicle control unit 13 configured to shorten the distance between the plurality of vehicles M1 to M4 when the determination unit 12 determines that the surrounding vehicles are capable of entering.

In the ECU 10, the actuator 60 is controlled such that the situation of the vehicle around the plurality of vehicles M1 to M4 that form the platoon Co, which is imaged by the camera 101 of the drone 100, is acquired, it is determined whether or not the surrounding vehicles can enter between the plurality of vehicles M1 to M4 that form the platoon Co in accordance with the situation of the surrounding vehicles, and the distance (that is, inter-vehicle distance) between the plurality of vehicles M1 to M4 is shortened when it is determined that the surrounding vehicles can enter. As described above, by acquiring the situation of the surrounding vehicles, which is imaged by the camera 101 of the drone 100, it is possible to appropriately grasp the situation of the vehicles around the platoon Co even when the platoon Co is formed. In addition, in accordance with the situation of the surrounding vehicles, when the surrounding vehicles can enter between the plurality of vehicles M1 to M4 that form the platoon Co, the plurality of vehicles M1 to M4 are controlled such that the distance between the plurality of vehicles M1 to M4 that form the platoon Co is shortened, and accordingly, it is possible to avoid entry of another vehicle between the plurality of vehicles M1 to M4, that is, the disturbance of the platoon Co during the platooning. As described above, according to the present embodiment, it is possible to provide a vehicle control device capable of avoiding the disturbance of the platoon during the platooning. In addition, according to the present embodiment, the situation of the surrounding vehicles imaged by the camera 101 of the drone 100 is acquired, and accordingly, during the platooning in which it is unlikely to grasp the surrounding, it is possible to effectively suppress the contact of another vehicle with the plurality of vehicles M1 to M4 that form the platooning Co.

When the plurality of vehicles M1 to M4 are traveling on a highway, the acquisition unit 11 may acquire the situation of the vehicle that travels on the merging lane of the highway as the situation of the surrounding vehicles, and the determination unit 12 may determine whether or not the vehicle that travels on the merging lane is capable of entering between two vehicles included in the plurality of vehicles M1 to M4 at the junction of the vehicles that travel on the merging lane. At the junction (exit) of a highway, other vehicles enter especially between the plurality of vehicles M1 to M4 that form the platoon Co, and the platoon is likely to be disturbed. In this regard, the situation of the vehicle that travels on the merging lane of the highway is acquired, it is determined whether or not the vehicle that travels on the merging lane can enter between the plurality of vehicles M1 to M4 at the junction, and accordingly, even at the junction of the highway where the platoon Co is likely to be disturbed, it is possible to appropriately avoid the disturbance of the platoon Co.

The vehicle control unit 13 may decelerate or accelerate the plurality of vehicles M1 to M4 in accordance with the expected position of the vehicle that travels on the merging lane with respect to the plurality of vehicles M1 to M4 at the junction. In addition to shortening the distance between the plurality of vehicles M1 to M4 that form the platoon Co, for example, when the vehicle M at the head of the platoon Co and the expected position of the vehicle that travels on the merging lane are close to each other (the entry of another vehicle is likely to occur at the head) at the junction, the plurality of vehicles M1 to M4 that form the platoon Co is decelerated, and the vehicle that travels on the merging lane is allowed to go first. At the same time, for example, when the vehicle M at the end of the platoon Co and the expected position of the vehicle that travels on the merging lane are close to each other (the entry of another vehicle is likely to occur at the end) at the junction, the plurality of vehicles M1 to M4 that form the platoon are accelerated and travel ahead of the vehicle that travels on the merging lane, and accordingly, it is possible to more reliably avoid the entry of the vehicle that travels on the merging lane between the plurality of vehicles M1 to M4 that form the platoon, and to more reliably avoid the disturbance of the platoon Co.

The vehicle control unit 13 may determine whether to decelerate or accelerate the plurality of vehicles M1 to M4 in consideration of the load amount of the plurality of vehicles M1 to M4. Since the speed of the plurality of vehicles M1 to M4 changes in accordance with the load amount, it is determined whether to decelerate or accelerate in consideration of the load amount, and accordingly, it is possible to more reliably avoid the entry of the vehicle that travels on the merging lane between the plurality of vehicles M1 to M4 that form the platoon.

The acquisition unit 11 may acquire the separation distance in the traveling direction between the plurality of vehicles M1 to M4 and the vehicle that travels on the lane next to the lane on which the plurality of vehicles M1 to M4 travel, as the situation of the surrounding vehicles, and the determination unit 12 may determine that the surrounding vehicles are capable of entering between two vehicles included in the plurality of vehicles M1 to M4 when the separation distance becomes smaller than the predetermined value. As described above, when the relative distance in the traveling direction with respect to the vehicle that travels on the next lane is shortened, that is, when the vehicle that travels on the next lane is likely to enter between the plurality of vehicles M1 to M4 that form the platoon Co when the vehicle has changed the lane, it is determined that the vehicle can enter, and accordingly, if the possibility of entry is high, it is possible to appropriately shorten the distance between the plurality of vehicles M1 to M4 that form the platoon Co, and to more reliably avoid the disturbance of the platoon Co.

What is claimed is:

1. A vehicle control device that controls platooning in which a plurality of vehicles travel while forming a platoon, the device comprising:
an acquisition unit configured to acquire a situation of a surrounding vehicle around the plurality of vehicles based on an imaging result by an imaging unit of a drone that flies around the plurality of vehicles;
a determination unit configured to determine whether or not the surrounding vehicle is capable of entering between two vehicles included in the plurality of vehicles in accordance with the situation of the surrounding vehicle acquired by the acquisition unit; and
a vehicle control unit configured to shorten a distance between the plurality of vehicles when the determination unit determines that the surrounding vehicle is capable of entering.

2. The vehicle control device according to claim 1,
wherein, when the plurality of vehicles are traveling on a highway, the acquisition unit acquires a situation of a vehicle that travels on a merging lane of the highway as the situation of the surrounding vehicle, and
wherein the determination unit determines whether or not the vehicle that travels on the merging lane is capable of entering between two vehicles included in the plurality of vehicles at a junction of the vehicle that travels on the merging lane.

3. The vehicle control device according to claim 2,
wherein the vehicle control unit decelerates or accelerates the plurality of vehicles in accordance with an expected position of the vehicle that travels on the merging lane with respect to the plurality of vehicles at the junction.

4. The vehicle control device according to claim 3,
wherein the vehicle control unit determines whether to decelerate or accelerate the plurality of vehicles in consideration of a load amount of the plurality of vehicles.

5. The vehicle control device according to claim 1,
wherein the acquisition unit acquires a separation distance in a traveling direction between the plurality of vehicles and a vehicle that travels on a lane next to a lane on which the plurality of vehicles travel, as the situation of the surrounding vehicle, and
wherein the determination unit determines that the surrounding vehicle is capable of entering between two vehicles included in the plurality of vehicles when the separation distance becomes smaller than a predetermined value.

6. A vehicle control system that controls platooning in which a plurality of vehicles travel while forming a platoon, the system comprising:
an imaging unit that is provided in a drone that flies around the plurality of vehicles and images a surrounding of the plurality of vehicles;
an acquisition unit configured to acquire a situation of a surrounding vehicle around the plurality of vehicles based on an imaging result by the imaging unit;
a determination unit configured to determine whether or not the surrounding vehicle is capable of entering between two vehicles included in the plurality of vehicles in accordance with the situation of the surrounding vehicle acquired by the acquisition unit; and
a vehicle control unit configured to shorten a distance between the plurality of vehicles when the determination unit determines that the surrounding vehicle is capable of entering.
